(19) United States
(12) Patent Application Publication
(10) Pub. No.: US 2010/0328216 A1
(43) Pub. Date: Dec. 30, 2010

(54) INFORMATION PROCESSING APPARATUS AND INPUT CONTROL METHOD

(75) Inventors: Yoshinori Honda, Nishitama-gun (JP); Shinichi Fukuda, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/813,208

(22) Filed: Jun. 10, 2010

(30) Foreign Application Priority Data
Jun. 30, 2009 (JP) 2009-156267

(51) Int. Cl. G06F 3/033

(52) U.S. Cl. 345/163

(57) ABSTRACT

According to one embodiment, an information processing apparatus with a display includes a wireless transfer module configured to receive an input operation request from an input operation module by use of a close proximity wireless transfer, and a controller configured to be connected to an external apparatus via the close proximity wireless transfer module, and to transit a mouse cursor displayed on the display to a display of the external apparatus in order to control the mouse cursor displayed on the display of the external apparatus with the information processing apparatus as a master.

### CROSS-REFERENCE TO RELATED APPLICATIONS

This application is based upon and claims the benefit of priority from Japanese Patent Application No. 2009-156267, filed Jun. 30, 2009, the entire contents of which are incorporated herein by reference.

### BACKGROUND

1. Field

One embodiment of the present invention relates to an information processing apparatus and an input control method which enable input control operations to be shared with a plurality of hosts.

2. Description of the Related Art

In general, a human interface device (HID) input device, such as a mouse, is connected to a personal computer or the like. The cursor on the display screen is controlled by operating the mouse. A plurality of hosts, such as personal computers, are connected to one another by a close proximity wireless transfer, such as a local area network (LAN) or Bluetooth (registered trademark). When the display device of each of the plurality of hosts shares the display of a single mouse, a multi-viewer of one of the plurality of hosts generally performs control. Since the multi-viewer performs a control single-handed, the processing load on the multi-viewer increases. Because of this problem, a mouse installed in each host is often used in turn without causing the multi-viewer of a single host to perform control. For example, Jpn. Pat. Appln. KOKAI Publication No. 2000-122806 discloses the technique for enabling a plurality of hosts to use a single mouse with the help of a distributor.

However, the technique written in Jpn. Pat. Appln. KOKAI Publication No. 2000-122806 requires a distributor to be provided additionally. To increase the number of hosts to be operated, it is necessary to replace the present distributor with a new one compatible with the increased number of hosts. In addition, a place where the distributor is installed is needed, making the installation complicated. Moreover, additionally providing a distributor causes a cost increase problem.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an exemplary configuration of an information processing apparatus and others according to an embodiment of the invention.

FIG. 2 is an exemplary block diagram schematically showing the configuration of an information processing apparatus according to the embodiment.

FIG. 3 is an exemplary block diagram showing a functional configuration of the information processing apparatus according to the embodiment.

FIG. 4 is an exemplary flowchart to explain an input control method for the information processing apparatus of the embodiment.

FIG. 5 is an exemplary pictorial diagram to explain the procedure for the input control method for the information processing apparatus of the embodiment.

FIG. 6 is an exemplary pictorial diagram to explain the procedure for the input control method for the information processing apparatus of the embodiment.

FIG. 7 is an exemplary pictorial diagram to explain the procedure for the input control method for the information processing apparatus of the embodiment.

FIG. 8 is an exemplary pictorial diagram to explain the procedure for the input control method for the information processing apparatus of the embodiment.

FIG. 9 is an exemplary pictorial diagram to explain the procedure for the transition of the mouse cursor in the input control method for the information processing apparatus of the embodiment.

FIG. 10 is an exemplary pictorial diagram showing a transition image of the mouse cursor in the input control method for the information processing apparatus of the embodiment.

FIG. 11 is an exemplary schematically shown a state where three hosts are registered as controlled objects into a controlling entity (or a master) in the input control method for the information processing apparatus of the embodiment.

FIG. 12 is an exemplary schematically shown a state where three hosts are registered as controlled objects into a controlling entity in the input control method for the information processing apparatus of the embodiment.

### DETAILED DESCRIPTION

Various embodiments according to the invention will be described hereinafter with reference to the accompanying drawings. In general, according to one embodiment of the invention, an information processing apparatus with a display, comprises a wireless transfer module configured to receive an input operation request from an input operation module by use of a close proximity wireless transfer; and a controller configured to be connected to an external apparatus via the wireless transfer module, and to transit a mouse cursor displayed on the display based on the input operation request to a display of the external apparatus in order to control the mouse cursor displayed on the display of the external apparatus with the information processing apparatus as a master.

Hereinafter, referring to the accompanying drawings, an embodiment of the present invention will be explained.

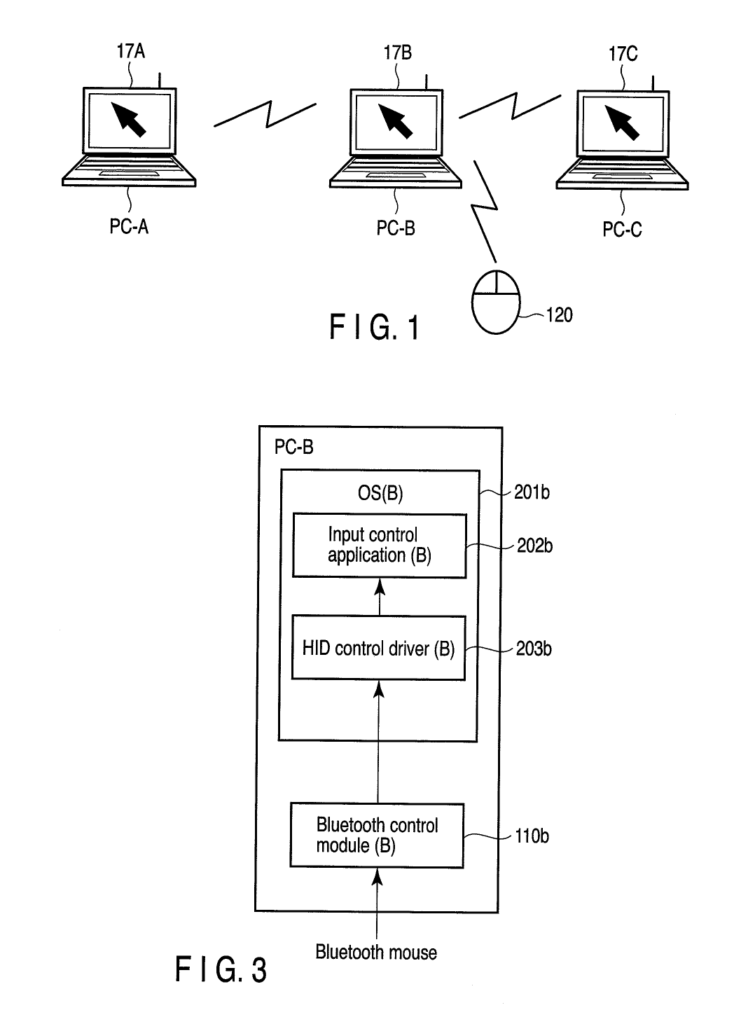

The configuration of an information processing apparatus according to an embodiment of the invention will be explained with reference to FIG. 1. The information processing apparatus of the embodiment is realized by, for example, a notebook personal computer (PC-B: host). In the embodiment, though the notebook personal computer PC-B is explained as the information processing apparatus, the invention is not limited to this. For instance, the information processing apparatus may be any suitable apparatus, provided that, like a personal digital assistant (PDA), it includes a display unit and an input operation unit using a close proximity wireless transfer.

The computer PC-B includes an input operation unit using a close proximity wireless transfer, such as Bluetooth (registered trademark), and a display (display) 17B. The input operation unit is a human interface device (HID), such as a mouse. In the embodiment, an example of using a Bluetooth mouse 120 capable of Bluetooth connection will be explained. While in the embodiment, a close proximity wireless transfer is explained, taking Bluetooth as an example, the invention is not limited to this. For instance, TransferJet or the like may be used as a close proximity wireless transfer.

First, a wireless connection is established by pairing the Bluetooth mouse 120 and computer PC-B (or by establishing the link between the Bluetooth mouse 120 and computer PC-B). The pairing enables the Bluetooth mouse 120 to control the mouse cursor on the display (display) 17B. When the wireless connection is established by pairing the Bluetooth mouse 120 with the computer PC-B, the computer PC-B which registers the wireless connection of the Bluetooth mouse 120 as a physical mouse serves as a controlling entity (or a master) in an input operation control. After having become a master in the input operation control, the computer PC-B pairs each of the other hosts, such as a computer PC-A and a computer PC-C, with the computer PC-B, thereby establishing the wireless connection. After the computer PC-A and computer PC-C are paired with the computer PC-B, the Bluetooth mouse 120 can control the mouse cursor on the displays 17A and 17C of the computers PC-A and PC-C, with the computer PC-B as the master (explained later).

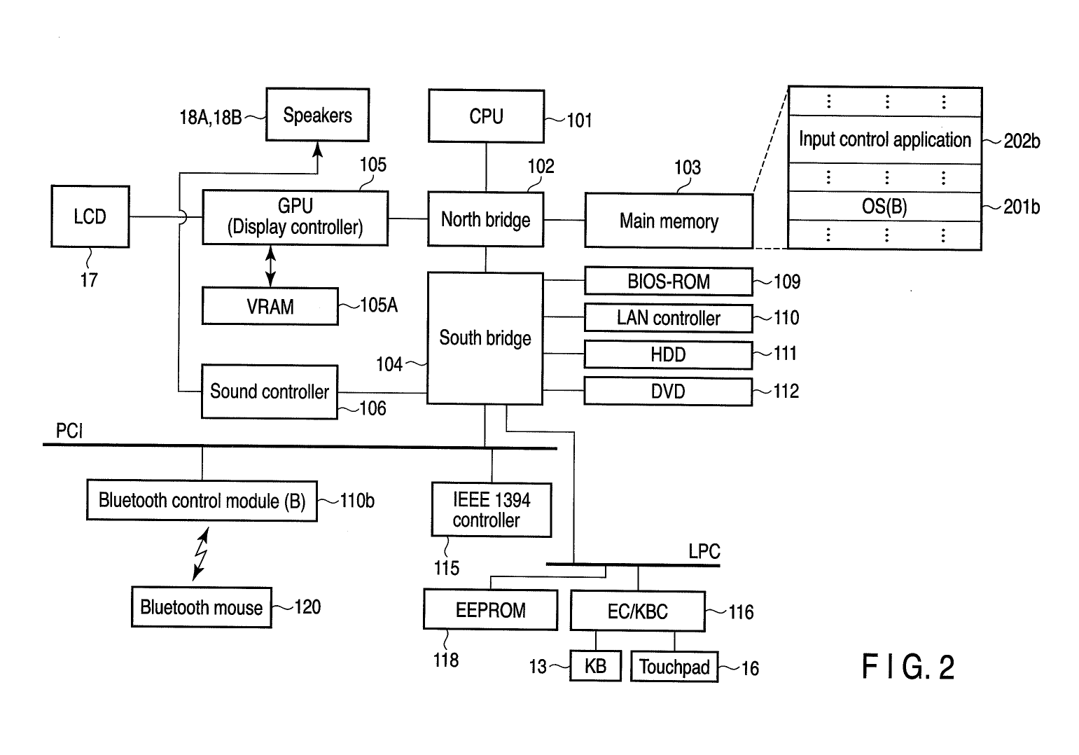

Next, a system configuration of the computer PC-B will be explained with reference to FIG. 2.

As shown in FIG. 2, the computer PC-B comprises a CPU 101, a north bridge 102, a main memory 103, a south bridge 104, a graphics processing unit (GPU) 105, a video memory (VRAM) 105A, a sound controller 106, a BIOS-ROM 109, a hard disk drive (HDD) 111, a DVD drive 112, an IEEE 1394 controller 115, an embedded controller/keyboard controller IC (EC/KBC) 116, an LCD (display) 17B, a Bluetooth control module 110, and an EEPROM 118.

The CPU 101 is a processor which controls the operation of the computer PC-B. The CPU 101 executes an operating system (OS) 201 loaded from the hard disk drive (HDD) 111 into the main memory 103 and various application programs, including an input control application program (B) 202b. The input control application program (B) 202b controls the mouse cursor on the display 17B on the basis of an input operation request received from the Bluetooth mouse 120 via a Bluetooth control module (B) 110b. The input control application program (B) 202b is a software program which, on the basis of an input operation request from the Bluetooth mouse 120, controls the mouse cursor on each of the displays 17A and 17C included in the computers PC-A and PC-C each paired with the computer PC-B in Bluetooth.

The Bluetooth control module (B) 110b pairs the computer PC-B and the Bluetooth mouse 120 in Bluetooth, thereby establishing the wireless connection. In addition, the Bluetooth control module (B) 110b pairs the computer PC-B with other computers, such as the computers PC-A and PC-C, in Bluetooth, thereby establishing the wireless communication. Suppose each of the computers PC-A and PC-C includes a Bluetooth control module for performing Bluetooth close proximity wireless transfer (described later). In the specification of Bluetooth, the following six stages are determined: they are (1) device search, (2) service search, (3) authentication, (4) entry, (5) connection, and (6) communication. In the specification, both of the device search and the service search are designed to respond to a request from each of the devices of the general public.

The north bridge 102 is a bridge device which connects a local bus of the CPU 101 and the south bridge 104. The north bridge 102 includes a memory controller which performs access control of the main memory 103. In addition, the north bridge 102 also has the function of communicating with the GPU 105 via, for example, a serial bus complying with the PCI EXPRESS standard.

The GPU 105 is a display controller which controls the LCD (display) 17B used as a display monitor of the computer PC-B. A display signal generated by the GPU 105 is sent to the display 17B of the display unit 12 by a close proximity wireless transfer.

The south bridge 104 controls each device on a Low Pin Count (LPC) bus and each device on a Peripheral Component Interconnect (PCI) bus. The south bridge 104 includes an Integrated Drive Electronics (IDE) controller for controlling the hard disk drive (HDD) 111 and the DVD drive 112. The south bridge 104 further has the function of communicating with the sound controller 106.

The sound controller 106, which is a sound source device, outputs audio data to be reproduced to the speakers 18A and 18B.

The embedded controller/keyboard controller IC (EC/KBC) 116 is a one-chip microcomputer into which an embedded controller for power management and a keyboard controller for controlling a keyboard (KB) 13 and a touchpad 16 are integrated. The embedded controller/keyboard controller IC (EC/KBC) 116 has the function of turning on/off the power of the computer PC-B.

Next, FIG. 3 is a block diagram showing a functional configuration of the computer PC-B.

The CPU 101 of the computer PC-B executes the OS (B) 201b, HID control driver 203b, and input a control application program (B) 202b loaded from the hard disk drive (HDD) 111 into the main memory 103. The Bluetooth control module 110b sends an input operation request (e.g., the movement of the mouse cursor) received from the Bluetooth mouse 120 to the input control application program (B) 202b which performs an input control in cooperation with the HID control driver (b) 203b. The input control application program (B) 202b controls the mouse cursor in cooperation with the HID control driver (b) 203b.

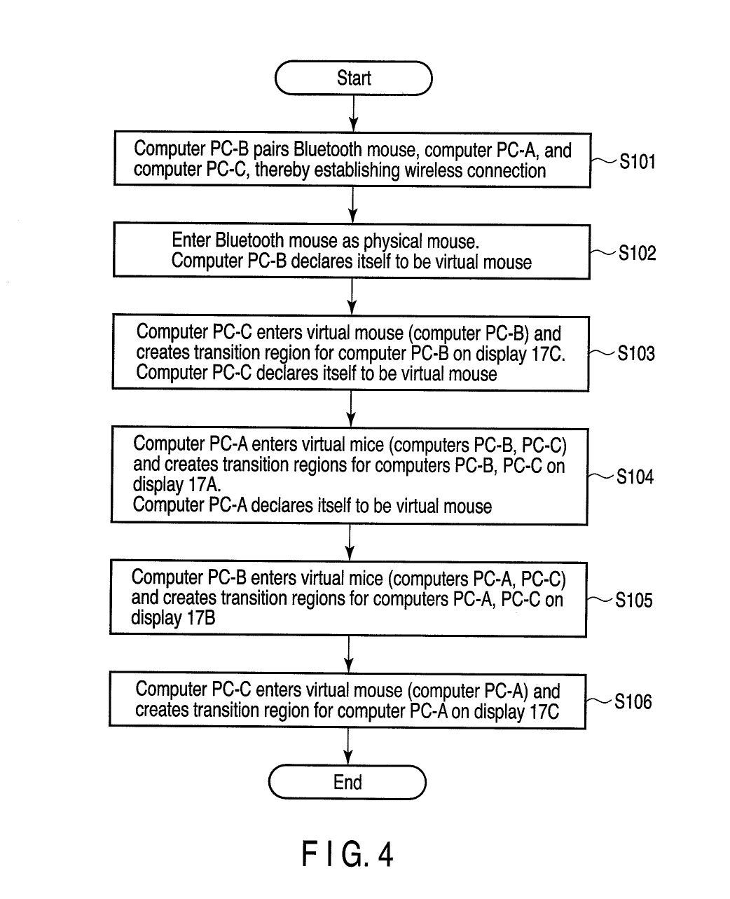

Next, FIG. 4 is a flowchart to explain an input control method relating to the information processing apparatus of the embodiment.

The CPU 101 of the computer PC-B starts up the input control application program (B) 202b stored in the HDD 111 or the like and loads it into the main memory 103.

The Bluetooth control module (B) 110b of the computer PC-B pairs the Bluetooth mouse 120, the computer PC-A, and the computer PC-C (or establishes a wireless connection) (block S101). This pairing enables Bluetooth close proximity wireless transfer. For example, if the computer PC-B is a master and the Bluetooth mouse 120 is a slave, a physical and a logical link between the master and slave is established. The physical link is established between the master and slave in a protocol layer at the same level as or lower than a Link Manager Protocol (LMP) layer, one of the Bluetooth protocol layers. The logical link is established between a Logical Link Control and Adaptation Protocol (L2CAP) layer, also one of the Bluetooth protocol layers, after the physical link is established between the master and slave. After the physical and logical links are established between the master and slave, data transmission and reception can be performed between the input control application of the master and that of the slave.

Thereafter, the input control application program (B) 202b of the computer PC-B registers the Bluetooth mouse 120 as a physical mouse (HID). Then, the computer PC-B declares the Bluetooth mouse to be a virtual mouse (block S102). The virtual mouse is such that the computer PC-B itself is regarded as a virtual mouse (HID). That is, the computer PC-B can be registered as a virtual mouse (HID) into another host.

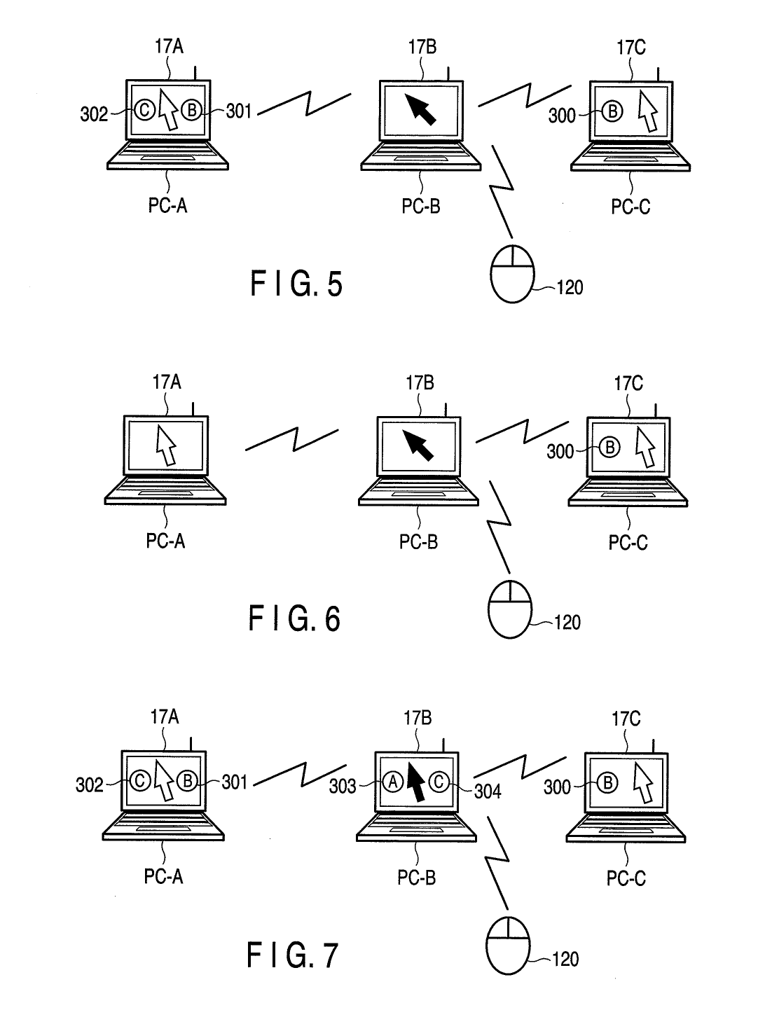

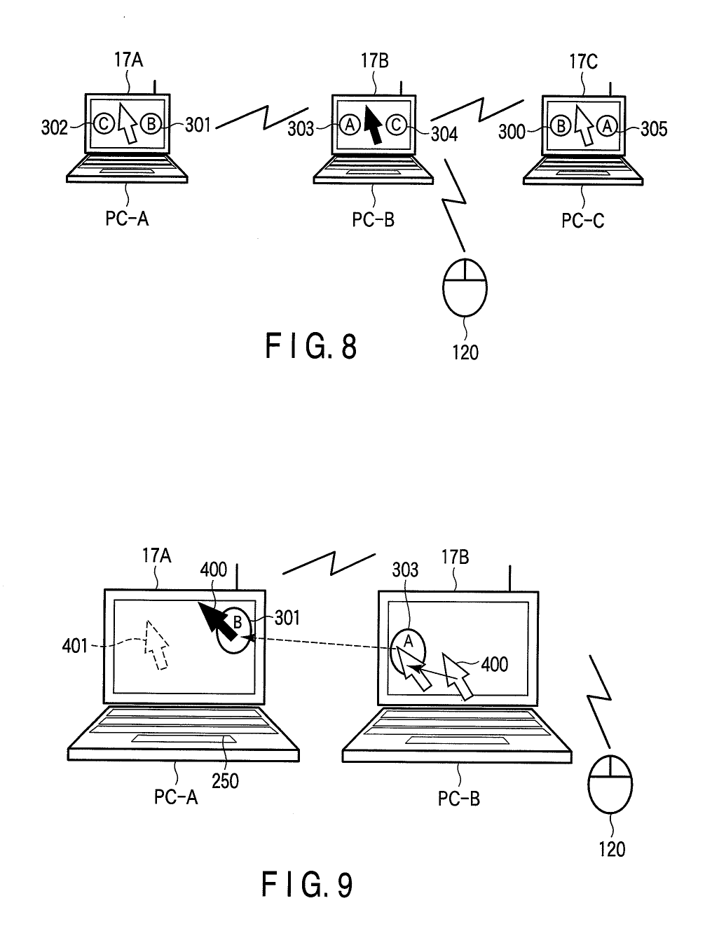

Next, the computer PC-C registers the computer PC-B declared to be a virtual mouse and creates a transition region 300 for the computer PC-B on the display 17C of the computer PC-C (FIG. 5). Thereafter, the computer PC-C declares itself to be a virtual mouse (block S103). Then, the computer PC-A registers the computers PC-B and PC-C declared to be virtual mice and creates transition regions 301 and 302 for the computers PC-B and PC-C on the display 17A of the computer PC-A (FIG. 6). Thereafter, the computer PC-A declares itself to be a virtual mouse (block S104). Then, the computer PC-B registers the computers PC-A and PC-C declared to be virtual mice and creates transition regions 303 and 304 for the computers PC-A and PC-C on the display 17B of the computer PC-B (block 5105 with referring to FIG. 7). Then, the computer PC-C registers the computer PC-A declared to be a virtual mouse and creates a transition region 305 for the computer PC-C on the display 17C of the computer PC-C (block 5106 with referring to FIG. 8). While in the embodiment, the computer PC-C registers a virtual mouse earlier than the computer PC-A, the invention is not limited to this. Actually, a virtual mouse is registered in the order of timing and therefore the order of entry is not determined beforehand. Accordingly, the order in which a virtual mouse is registered is not restricted to the above-described order.

As described above, the mouse cursor transition regions 300 to 305 are created on the displays of the respective connectable hosts using Bluetooth close proximity wireless transfer. In the created mouse cursor transition regions 300 to 305, when the mouse cursor registers each of the transition regions, this enables the mouse cursor to move from the transition source to the transition destination. For example, as shown in FIG. 9, when the mouse cursor 400 enters in the transition region 303 displayed on the display 17B of the computer PC-B, the mouse cursor is caused to transit to the display 17A of the computer PC-A, because the transition region 303 is a transition region to the computer PC-A. When the mouse cursor is caused to transit to the display 17A of the computer PC-A, for example, the mouse cursor 400 is output from the transition region 301. The region from which the mouse cursor 400 is output may be the transition region 301 or another transition region (e.g., transition region 302). There may be provided a special output region to which the mouse cursor is output. In the embodiment, the original mouse cursor 401 of the computer PC-A is displayed in advance on the display 17A of the computer PC-A. The original mouse cursor 401 is controlled from the touchpad 250 and others included in the computer PC-A. When the mouse cursor 400 is caused to transit to the display 17A of the computer PC-A (the mouse cursor 400 disappears temporarily from the display 17B), the original mouse cursor 401 disappears temporarily from the display 17A. Then, the mouse cursor 400 caused to transit from the display 17B is output. The mouse cursor 400 moves on the display 17A on the basis of the input control by the Bluetooth mouse 120. That is, the control of the original mouse cursor 401 is passed from the input control application (B) 202b of the computer PC-A to that of the computer PC-B. In this state, the mouse cursor 400 operates on the basis of the input control by the Bluetooth mouse 120.

When the mouse cursor 400 enters in the transition region 301, the mouse cursor 400 transits to the display 17B and the original mouse cursor 401 of the computer PC-A is displayed on the display 17A. A control of the original mouse cursor 401 of the computer PC-A is returned to the computer PC-A so that the mouse cursor 401 may be controlled from the touchpad 250 and others included in the computer PC-A. As described above, the mouse cursor which enters in the transition region is displayed on the display at the transition destination and the original mouse cursor displayed on the display at the transition destination disappears temporarily. Then, when the mouse cursor caused to transit is transited to another display, the original mouse cursor appears again.

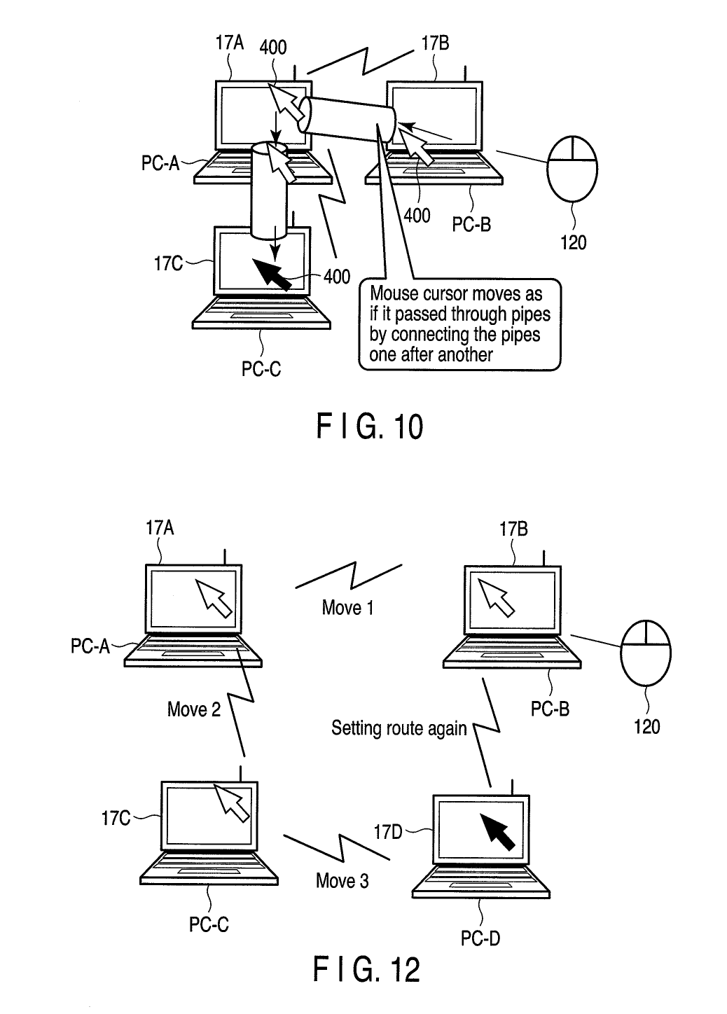

FIG. 10 shows the concept of transition of the mouse cursor.

The mouse cursor 400 can move from the display 17b of the computer PC-B acting as a master paired with the Bluetooth mouse 120 (physical mouse), pass through various transition regions one after another, and reach to a host at the transition destination (as if it moved through a pipe).

FIG. 11 is a block diagram showing the configuration of an input control performed between hosts. FIG. 8 shows a state where the computer PC-B acting as a master registers the computers PC-A and PC-C serving as hosts according to the sequence of FIG. 4. In this state, the computer PC-B, which registers the Bluetooth mouse 120 acting as a physical mouse, acts as a master. With the computer PC-B as a master, for example, the computer PC-C and then the computer PC-A are registered under the computer PC-B (they are not necessarily registered in this order and may be registered in another order). The input control application (B) 202b of the computer PC-B sends an input operation request input from the Bluetooth mouse 120 to the HID control driver (C) 203c and the input control application (C) 202c via the Bluetooth control module (B) 110b and the Bluetooth control module (C) 110c of the computer PC-C. The input control application (C) 202c controls the mouse cursor on the display 17C on the basis of the received input operation request. The input control application (C) 202c performs this control in cooperation with the HID control driver (C) 203c under the control of the input control application 17B of the computer PC-B acting as a master. Then, the input control application (C) 202c of the computer PC-C sends the input operation request input from the Bluetooth mouse 120 to the HID control driver (A) 203 and the input control application (A) 202a via the Bluetooth control module (C) 110c and the Bluetooth control module (A) 110a of the computer PC-A. The input control application (A) 202a controls the mouse cursor on the display 17A on the basis of the received input operation request. The input control application (A) 202a performs this control in cooperation with the HID control driver (A) 203a under the control of the input control application 17B of the computer PC-B acting as a master. Even when the number of hosts increases to 4 or more, the input control application (A) 202a similarly performs the mouse cursor by passing through the registered hosts one after another under the control of the input control application 17B of the computer PC-B acting as a master. As described above, the sequence (route) registered after the hosts (or controlled objects) excluding the master (the computer PC-B) are declared to be virtual mice is not determined beforehand and may be changed, depending on conditions, such as entry timing or processing speed.

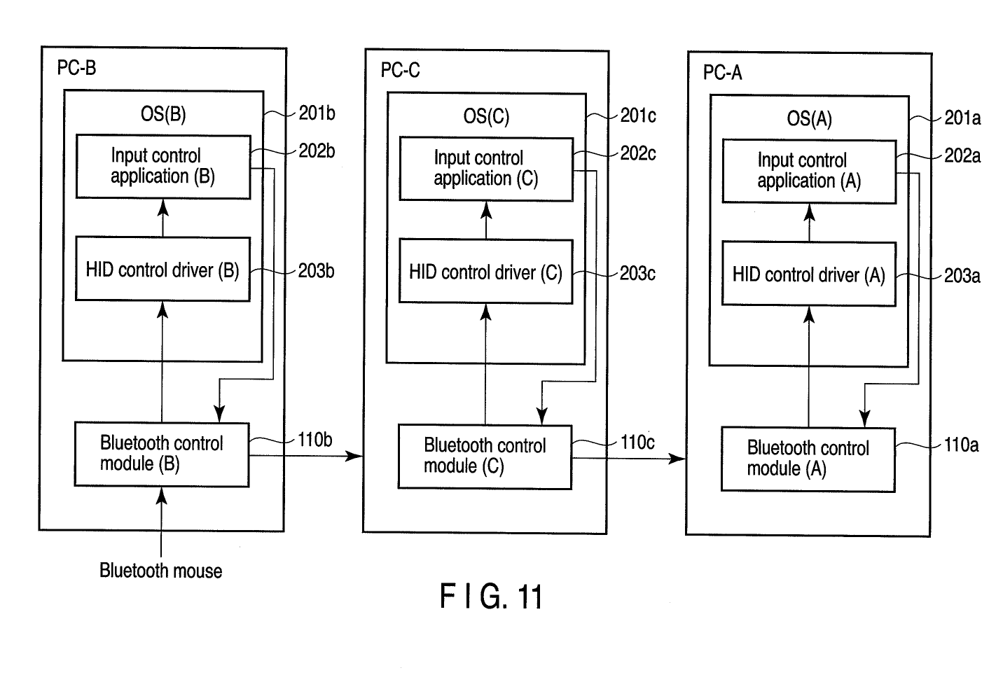

FIG. 12 is a pictorial diagram showing a state where three hosts (the computers PC-A, PC-C and PC-D) have been registered as controlled objects into a master (the computer PC-B). If the number of controlled objects is increased as described above, the order (route) in which the hosts declared to be virtual mice are registered becomes complicated, which might decrease the efficiency. For example, when the mouse cursor is caused to transit from the display 17B of the computer PC-B to the display 17D of the computer PC-D, first, the mouse cursor is caused to transit to the display 17A of the computer PC-A (move 1). Next, the mouse cursor is caused to transit to the display 17C of the computer PC-C (move 2). Thereafter, the mouse cursor is caused to transit to the display 17D of the computer PC-D (move 3). In such a case (the moves 1 to 3), the efficiency decreases. To avoid this problem, the route of the transition of the mouse cursor from the display 17B of the computer PC-B to the display 17D of the computer PC-D is newly set again. This causes the mouse cursor to transit directly from the display 17B of the computer PC-B to the display 17D of the computer PC-D, enabling the move efficiency of the mouse cursor to increase. In this way, the registered route can be reset as needed.

With the above-described embodiment, the mouse cursor can be moved easily between hosts by use of a close proximity wireless transfer in input control operations. Even when the number of registered hosts increases, this can be dealt with easily without adding special hardware.

Furthermore, the information processing apparatus of the embodiment can be realized by not only the computer PC-B but also various consumer information processing units, including a personal digital assistant (PDA). In addition, the function of the input control application can be realized by such hardware as a DSP or a microcomputer. A module can be accomplished in software and hardware.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus with a first display, comprising:
a wireless transfer module configured to receive an input operation request from an input operation module by a close proximity wireless transfer; and
a master controller connected to an external apparatus via the wireless transfer module, the master controller being configured to move a cursor on the first display based on the input operation request to a second display of the external apparatus.

2. The information processing apparatus of claim 1, wherein the information processing apparatus and the external apparatus are configured to register the external apparatus and the information processing apparatus as a virtual input operation module and the information processing apparatus is configured to register the external apparatus as a controlled object.

3. The information processing apparatus of claim 2, wherein the controller is configured to display a first transition region on the second display for moving the cursor from the second display to the first display and to display a second transition region on the first display for moving the mouse cursor from the first display to the second display after the external apparatus and the information processing apparatus are registered as the virtual input operation module.

4. The information processing apparatus of claim 1, wherein the controller is configured to display the cursor on the second display instead of an existing cursor which has been displayed on the second display.

5. The information processing apparatus of claim 1, wherein the controller is configured to display the cursor on the first display instead of an existing cursor which has been displayed on the first display.

6. An input control method for an information processing apparatus with a first display, the information processing apparatus comprising a wireless transfer module configured to receive an input operation request from an input operation module by a close proximity wireless transfer, the method comprising:
connecting the information processing apparatus to an external apparatus via the wireless transfer module;
moving a cursor on the first display based on the input operation request to a second display of the external apparatus.

7. The input control method of claim 6, wherein the information processing apparatus and the external apparatus are configured to register the external apparatus and the information processing apparatus as a virtual input operation module and the information processing apparatus is configured to register the external apparatus as a controlled object.

8. The input control method of claim 7, wherein the second display is configured to display a first transition region for moving the cursor from the second display to the first display and the first display is configured to display a second transition region for moving the cursor from the first display to the second display.

9. The input control method of claim 6, further comprising:
displaying the cursor on the second display instead of an existing cursor which has been displayed on the second display.

10. The input control method of claim 6, further comprising:
displaying the cursor on the first display instead of an existing cursor which has been displayed on the first display.
